(19) United States
(12) Patent Application Publication
(10) Pub. No.: US 2021/0374771 A1
(43) Pub. Date: Dec. 2, 2021

(54) DATA ANALYSIS SUPPORT APPARATUS AND DATA ANALYSIS SUPPORT METHOD

(71) Applicant: Hitachi, Ltd., Tokyo (JP)

(72) Inventors: Yusuke NISHI, Tokyo (JP); Shizhen HU, Tokyo (JP); Satoshi TORIKAI, Tokyo (JP); Hiroshi FUJII, Tokyo (JP); Naoshi MANIWA, Tokyo (JP)

(21) Appl. No.: 17/200,410

(22) Filed: Mar. 12, 2021

(30) Foreign Application Priority Data
May 29, 2020 (JP) 2020-094310

(51) Int. Cl. G06Q 30/02

(52) U.S. Cl. CPC G06Q 30/0201

(57) ABSTRACT

A data analysis support apparatus is configured to acquire first result information which is result information acquired for a product produced through a prescribed step, and which includes information indicating a first processing time period which is a processing time period of the step for a first number of the products, and second result information which is result information including information indicating a second processing time period which is a processing time of the step for a second number of the products produced through the step, the second number being different from the first number, and convert the first result information and the second result information into a plurality of result information sets by performing time-division of the first result information and/or the second result information such that the result information sets each indicate a time period taken to perform the step for the same unit number of the products.

### CROSS-REFERENCE TO RELATED APPLICATION

This application claims priority pursuant to Japanese patent application No. 2020-094310, filed on May 29, 2020, the entire disclosure of which is incorporated herein by reference.

### BACKGROUND

### Technical Field

The present invention relates to a data analysis support apparatus and a data analysis method.

### Related Art

JP-2017-68816-A discloses a management system that is formed in order to enable detailed production management even in a production site where order-based production management is carried out. The management system is linked with a production line including one or more pieces of equipment, each of the pieces of equipment is formed so as to process each of workpieces according to order information that includes designation of the type of an item to be produced and designation of the number of items to be produced, processing-related event information that is generated in each of the pieces of equipment is collected, the collected event information is classified into groups of event information generated for the identical workpieces, on the basis of the respective generation sources and the details of the event information, data indicating the processing state of each workpiece is generated on the basis of the event information belonging to the corresponding classification group, and the processing progression statuses of workpieces, which are processed according to the order information, are visualized on the basis of the generated data.

In recent years, smart factories are being realized in product producing sites. In a smart factory, various types of data (data on equipment operating statuses, inspections of product qualities, environments, and the like) are acquired through various sensors and equipment, and the acquired data is visualized and analyzed, whereby the productivities and the quality of products are improved.

In a product producing site, it is important to manage the production state. In a case where an abnormality such as a delay in processing at a step has occurred in the production state, a user who is, for example, a manager of a department having charge of the step, needs to promptly get to know the occurrence of the abnormality and the production state. As a method for allowing the user to promptly get to know the state of the site, there has been a mechanism for presenting information that indicates the state of the site (information about the start time and the end time of each production step (a cutting step, an assembling step, or the like) for each product, hereinafter, referred to as “result information”) to a user in real time.

While an abnormality in the production state is detected, the production efficiency (a time period that is taken for a prescribed number of products to undergo a step) in a certain step for a prescribed unit number of products (e.g., one product) is required in some cases. However, information that is transmitted from a production site such as a production factory, does not always include information about the prescribed unit number. Only information indicating a time period taken to perform the step on all the unit number of products may be included. In this case, proper detection of an abnormality in the production state fails, or the information needs to be acquired by another method.

This situation will be specifically explained with reference to FIG. 14. Graphs A and B in FIG. 14 each indicate some result information sets in graph form with a progression status of the step indicated by an ordinate and a time axis indicated by an abscissa. In the graphs A and B, a circular mark (plot) and a triangular mark (plot) correspond to the start time of the step and the end time of the step, respectively. Further, the correspondence between the start time and the end time of each of the result information sets is shown by a line connecting the marks. It is noted that the slope of the line represents a step progression degree per unit time.

Here, in the graph A, all the lines are based on result information about the same unit number of products. Thus, a user can easily determine the presence/absence of an abnormality in the production state by comparing the slopes of the lines. That is, in this example, the slope of a line indicating that the start time is “9:40” and the end time is “9:50” is more moderate than those of the remaining lines so that the user can easily determine that the result information corresponding to this line includes an abnormality. However, if a plurality of result information sets acquired from the production site are not based on the same unit number of products, the user cannot properly determine the presence/absence of an abnormality from a graph in which the result information sets are shown by a method the same as the above one. For example, like the graph A, the graph B also shows that three products are produced during a time period from a start time “9:00” to an end time “9:15,” two products are produced during a time period from a start time “9:25” to an end time “9:35,” and two products are produced during a time period from a start time “9:40” to an end time “9:55.” However, the graph B differs from the graph A in that, in the graph B, the line connecting the start time “9:00” to the end time “9:15” indicates a case of producing “three” products, the line connecting the start time “9:25” to the end time “9:35” indicates a case of producing “two” products, and the line connecting the start time “9:40” to the end time “9:55” indicates a case of producing “two” products. The slopes of these lines are different in the meanings thereof. Therefore, the user cannot properly determine the presence/absence of an abnormality even by simply comparing the slopes of these lines.

In JP-2017-68816-A, even in a case where one result information set (particularly, a start time and an end time) is acquired after a plurality of products are produced, equipment on/off information is additionally acquired and used to estimate a pseudo result information set to be acquired when one product is produced. Then, the production state is displayed. However, in order to acquire the equipment on/off information, a special device such as a programmable logic controller (PLC) needs to be installed, a special communication environment needs to be prepared, or a system needs to be greatly repaired, for example. Thus, there is a problem that a big burden is required to acquire the equipment on/off information.

### SUMMARY

The present invention has been made in view of the above circumstances, and an object of the present invention is to provide a data analysis support apparatus and a data analysis support method by which the presence/absence of an abnormality in a product producing state can be properly determined on the basis of a plurality of result information sets that are provided in different forms from a production site.

One aspect of the present invention for achieving the aforementioned object, is a data analysis support apparatus that is formed of an information processing apparatus. The data analysis support apparatus comprises a result information acquisition unit configured to acquire first result information which is result information acquired for a product produced through a prescribed step, the first result information including information that indicates a first processing time period which is a processing time period of the step for a first number of the products, and second result information which is result information including information that indicates a second processing time period which is a processing time of the step for a second number of the products produced through the step, the second number being different from the first number, and a result information conversion unit configured to convert the first result information and the second result information into a plurality of result information sets by performing time-division of the first result information and/or the second result information such that the result information sets each indicate a time period taken to perform the step for a same unit number of the products.

According to the present invention, the presence/absence of an abnormality in a production state can be properly determined on the basis of a plurality of result information sets in different forms that are provided from a production site.

It is to be noted that problems, configurations, and effects other than the aforementioned ones will be apparent from an embodiment explained below.

### BRIEF DESCRIPTION OF THE DRAWINGS

FIG. 1 is a diagram schematically illustrating the configuration of an analysis support system;

FIG. 2 illustrates a hardware configuration example of an information processing apparatus constituting an analysis support system;

FIG. 3 is a diagram illustrating main functions included in the data analysis support apparatus;

FIG. 4 shows one example of result information;

FIG. 5 shows one example of production management information;

FIG. 6 shows one example of display information;

FIG. 7 is a flowchart for explaining a data analysis process;

FIG. 8 is a flowchart for explaining a conversion necessity/unnecessity determination process;

FIG. 9 is a flowchart for explaining a display process;

FIG. 10 is a flowchart for explaining an abnormality determination/information presenting process;

FIG. 11 shows one example of a screen displaying analysis support information;

FIG. 12 shows one example of a screen displaying analysis support information;

FIG. 13 is a flowchart for explaining one example of a production management information updating process; and

FIG. 14 is a display example of result information.

### DESCRIPTION OF EMBODIMENTS

Hereinafter, an embodiment of the present invention will be explained with reference to the drawings. It is to be noted that the following description and drawings exemplify the present invention. Omission and simplification are included, as appropriate, for clarification of the description. The present invention can be implemented by various other embodiments. Unless otherwise defined, the number of components may be one, or may be two or more.

In addition, in the following explanation, a term “information” is used to explain various types of data. The various types of data may be expressed by another data structure such as a table or a list. Further, terms “identifier,” “ID,” and the like are used to explain identification information. These terms can be replaced with each other. In addition, in the following explanation, the character “S” before a reference numeral means a process step.

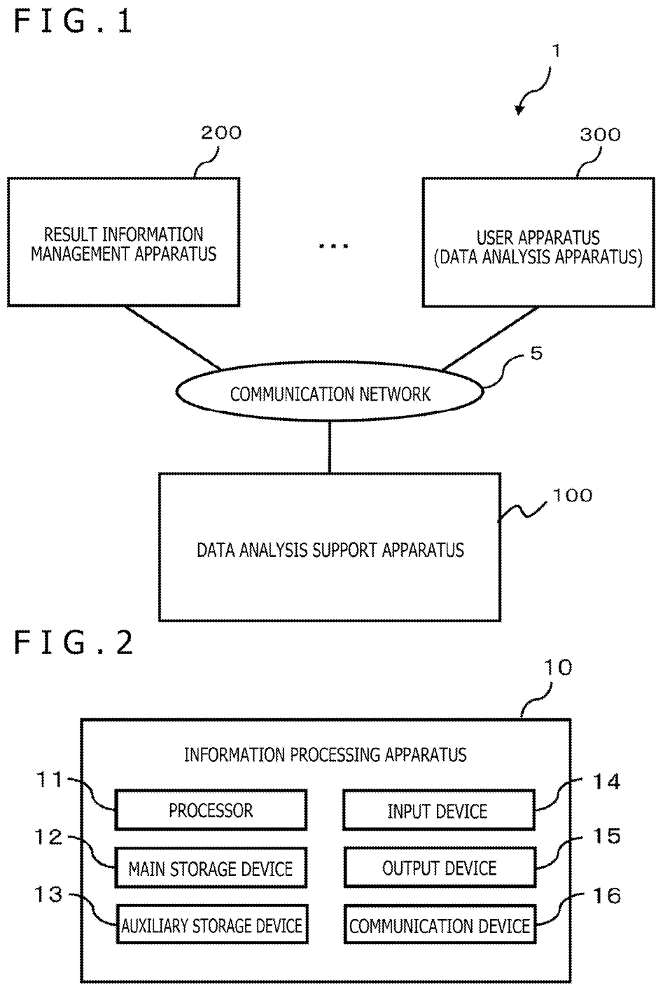

FIG. 1 schematically illustrates the configuration of an information processing system (hereinafter, referred to as “data analysis support system 1”) which is shown as one embodiment of the present invention. As illustrated in FIG. 1, the data analysis support system 1 includes a data analysis support apparatus 100, a result information management apparatus 200, and a user apparatus 300 (data analysis apparatus). These apparatuses are information processing apparatuses (computers), and are connected to one another via a communication network 5 such that mutual communication can be performed among these apparatuses. The communication network 5 is a data communication network such as a local area network (LAN) or a wide area network (WAN), or is a dedicated line, for example.

The result information management apparatus 200 is an information processing apparatus that is operated by an organization such as a product producing site such as a factory or a company for managing the site, for example, and is an IoT server of an IoT system or edge computing, for example. The result information management apparatus 200 manages (stores) result information 111 which is acquired through a sensor, production equipment, or the like, installed in the production site. The result information 111 is sensor data or IoT data, for example, and includes information about the production state of the site (e.g., the number of produced products, the start time and the end time of each step, a worker who carries out each step).

The user apparatus 300 is operated by an organization such as a company for managing the site, for example, and is manipulated by a user such as a manager of the organization. The user apparatus 300 presents, to the user, information (e.g., result information or an analysis result of the result information) transmitted from the data analysis support apparatus 100. Further, the user apparatus 300 transmits information acquired from the user to the data analysis support apparatus 100.

The data analysis support apparatus 100 performs information processing concerning management of the product producing state. The data analysis support apparatus 100 provides, to the user apparatus 300, information about the production state of the site (e.g., result information, or information indicating an abnormality in the production state of the site) on the basis of the result information 111 transmitted from the result information management apparatus 200.

FIG. 2 illustrates a hardware configuration example of the information processing apparatuses (the data analysis support apparatus 100, the result information management apparatus 200, and the user apparatus 300) constituting the data analysis support apparatus 1. As illustrated in FIG. 2, an information processing apparatus 10 includes a processor 11, a main storage device 12, an auxiliary storage device 13, an input device 14, an output device 15, and a communication device 16. The information processing apparatus 10 may be realized by using a virtual information processing resource that is provided by a virtualization technology, a processing space separation technology, or the like. For example, the virtual information processing resource is a virtual server a part or the entirety of which is provided by a cloud system. Further, all or some of the functions provided by the information processing apparatus 10 may be implemented by, for example, a service which a cloud system provides via an application programming interface (API) or the like. Moreover, the data analysis support apparatus 100, the result information management apparatus 200, and the user apparatus 300 may be formed of a plurality of the information processing apparatuses 10 that are connected such that communication thereamong can be performed.

In FIG. 2, the processor 11 is formed by using a central processing unit (CPU), a micro processing unit (MPU), a graphics processing unit (GPU), a field programmable gate array (FPGA), an application specific integrated circuit (ASIC), or an artificial intelligence (AI) chip, for example.

The main storage device 12 stores a program and data, and is a read only memory (ROM), a random access memory (RAM), or a nonvolatile memory (non-volatile RAM (NVRAM)), for example.

For example, the auxiliary storage device 13 is a solid state drive (SSD), a hard disk drive, an optical storage device (e.g., a compact disc (CD) or a digital versatile disc (DVD)), a storage system, a reading/writing device for recording mediums such as integrated circuit cards (IC cards), secure digital cards (SD cards), and optical recording mediums, or a recording region in a cloud server. Programs and data can be read into the auxiliary storage device 13 via a recording medium reading device or the communication device 16. Programs and data stored in the auxiliary storage device 13 are sequentially read into the main storage device 12. It is to be noted that the auxiliary storage device 13 forms a function (hereinafter, referred to as “storage unit”) for storing various types of data.

The input device 14 is an interface that receives an input from the outside, and is a keyboard, a mouse, a touch panel, a card reader, a pen input type tablet, or a sound input device, for example.

The output device 15 is an interface that outputs various information about processing progression, process results, and the like. The output device 15 is a display device (e.g., a liquid crystal monitor, a liquid crystal display (LCD), or a graphics card) that visualizes the aforementioned various information, a device (a sound output device (e.g., a loudspeaker)) that converts the aforementioned various information into voice, or a device (e.g., printing device) that converts the aforementioned various information into texts, for example. It is to be noted that, for example, the information processing apparatus 10 may be configured to exchange information with a separate apparatus via the communication device 16. For example, the information processing apparatus 10 may exchange information with a separate apparatus over the internet.

It is to be noted that the input device 14 and the output device 15 constitute a user interface to receive information from a user, and present information to the user.

The communication device 16 implements communication with a separate apparatus. The communication device 16 is a wired or wireless type communication interface that implements communication with a separate apparatus over a communication network (e.g., the internet, a LAN, a WAN, a dedicated line, or a public communication network). The communication device 16 is a network interface card (NIC), a wireless communication module, or a USB module, for example.

For example, an operating system, a file system, a database management system (DBMS) (e.g., relational database or NoSQL), a key-value store (KVS), and any other type of software (e.g., software, middleware, and various applications for implementing a user interface through graphical user interface (GUI) by the input device 14 and the output device 15) may be installed in the information processing apparatus 10.

Each of the functions of each of the information processing apparatuses (the data analysis support apparatus 100, the result information management apparatus 200, and the user apparatus 300) constituting the data analysis support system 1 are implemented by the processor 11 reading out and executing a program stored in the main storage device 12, or is implemented by hardware (e.g., an FPGA, an ASIC, or an AI chip) constituting the apparatus. In addition, the information processing apparatuses each store various types of information (data) as a table of a database that is provided by a DBMS, or as a file being managed by a file system, for example.

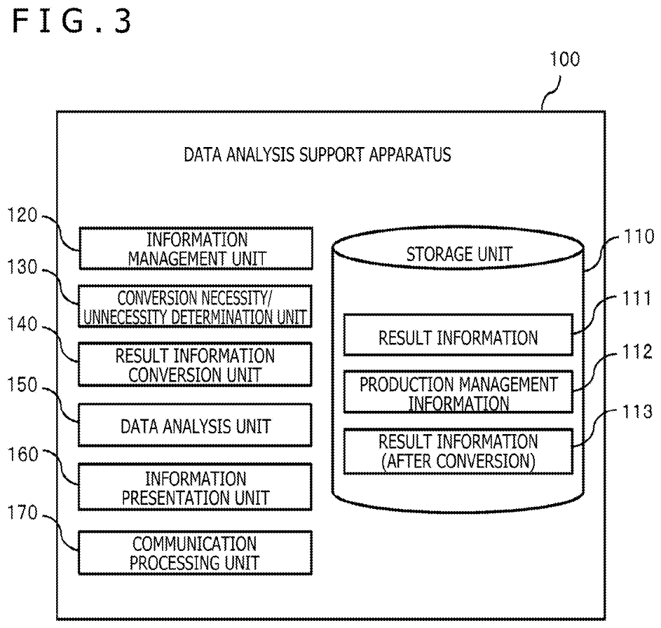

FIG. 3 illustrates main functions included in the data analysis support apparatus 100. As illustrated in FIG. 3, the data analysis support apparatus 100 includes functions of a storage unit 110, an information management unit 120 (result information acquisition unit), a conversion necessity/unnecessity determination unit 130, a result information conversion unit 140, a data analysis unit 150, an information presentation unit 160, and a communication processing unit 170. Each of these functions is implemented by the processor 11 of the data analysis support apparatus 100 reading out and executing a program stored in the main storage device 12 of the data analysis support apparatus 100, or is implemented by hardware (e.g., an FPGA, an ASIC, or an AI chip) of the data analysis support apparatus 100.

The storage unit 110 stores the result information 111, production management information 112, and result information (after conversion) 113. The storage unit 110 stores these types of information as a table of a database or as a file being managed by a file system, for example.

The information management unit 120 acquires the result information 111 from the result information management apparatus 200 via the communication network 5. Further, the information management unit 120 updates the production management information 112 by using the acquired result information 111. A method for updating the production management information 112 will be described later in detail.

The conversion necessity/unnecessity determination unit 130 determines whether conversion of the result information 111 is necessary or unnecessary (whether conversion of the result information 111 to information for a prescribed unit number of products (the result information (after conversion) 113) is necessary or unnecessary). Determination on whether conversion of the result information 111 is necessary or unnecessary will be described later in detail.

The result information conversion unit 140 creates the result information (after conversion) 113 by converting the result information 111 for which the necessity to be converted has been determined by the conversion necessity/unnecessity determination unit 130.

The data analysis unit 150 determines the presence/absence of an abnormality in the production state of a production site on the basis of the result information 111/the result information (after conversion) 113 and the production management information 112. It is to be noted that, in a case where the result information 111 has been converted, the data analysis unit 150 determines the presence/absence of an abnormality in the production state of the production site on the basis of the result information (after conversion) 113, and, in a case where the result information 111 has not been converted, the data analysis unit 150 determines the presence/absence of an abnormality in the production state of the production site on the basis of the result information 111.

The information presentation unit 160 provides (transmits), to the user apparatus 300, information indicating the state of the production site or information indicating the presence/absence of an abnormality in the production state of the site (hereinafter, referred to as “analysis result”). For example, the information presentation unit 160 creates a screen showing the analysis result (hereinafter, referred to as “analysis result presentation screen”), and transmits the generated analysis result presentation screen to the user apparatus 300.

The communication processing unit 170 exchanges various types of information with a separate apparatus via the communication network 5. For example, the communication processing unit 170 acquires the result information 111 from the result information management apparatus 200. Further, for example, the communication processing unit 170 transmits the analysis result presentation screen to the user apparatus 300.

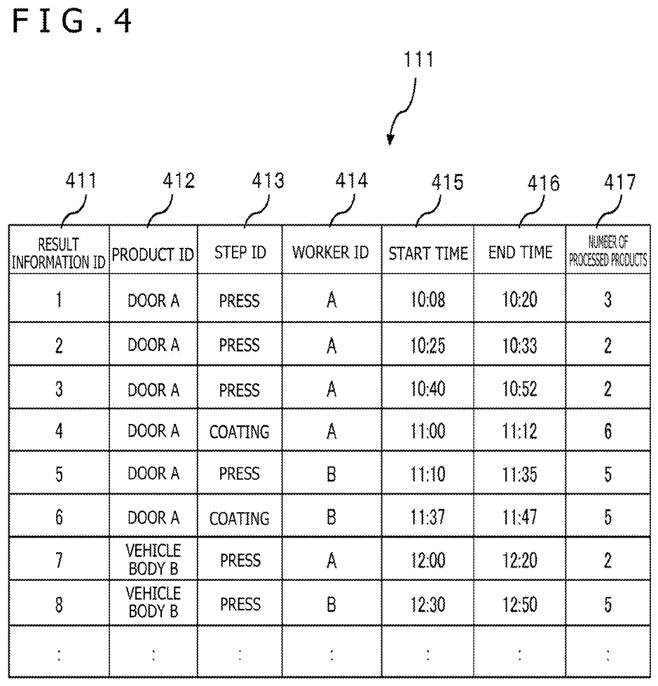

FIG. 4 shows one example of the result information 111. As shown in FIG. 4, the result information 111 is formed of one or more entries (records) each including a result information ID 411, a product ID 412, a step ID 413, a worker ID 414, a start time 415, an end time 416, and the number of processed products 417. One entry in the result information 111 corresponds to one result information set acquired from the result information management apparatus 200.

In the above items, a result information identifier (hereinafter, referred to as “result information ID”) is set in the result information ID 411. Information (an identifier of a product (product type) in the present embodiment, and hereinafter, referred to as “product ID”) indicating about which product (product type) the corresponding result information indicates, is set in the product ID 412. It is to be noted that the concept of a product or a product type is optionally set in the production site, for example. Information (an identifier of a step in the present embodiment, hereinafter referred to as “step ID”) indicating which step for this product the result information is about is set in the step ID 413. Information (hereinafter, referred to as “worker ID”) indicating a worker who carries out this step is set in the worker ID 414. A clock time at which the step for this product (all products, if the number of products to be produced is two or more) is started, is set in the start time 415. A clock time at which the step for this product (all products, if the number of products to be produced is two or more) is ended, is set in the end time 416. It is to be noted that the start time 415 and the end time 416 may include information about a date. Information indicating the number of the products processed in this step is set in the number of processed products 417.

For example, in FIG. 4, an entry having “1” set as the result information ID indicates that a step the step ID of which is “press” for a production the production ID of which is “door A” is performed by a worker the worker ID of whom is “worker A” during a time period from “10:08” to “10:20,” and that the number of the processed products is “three.”

It is to be noted that the result information 111 may further include information about equipment for carrying out a step, and various information about the production state such as a material to be processed, for example. In addition, an entity of providing the result information 111 is not necessarily limited to the result information management apparatus 200.

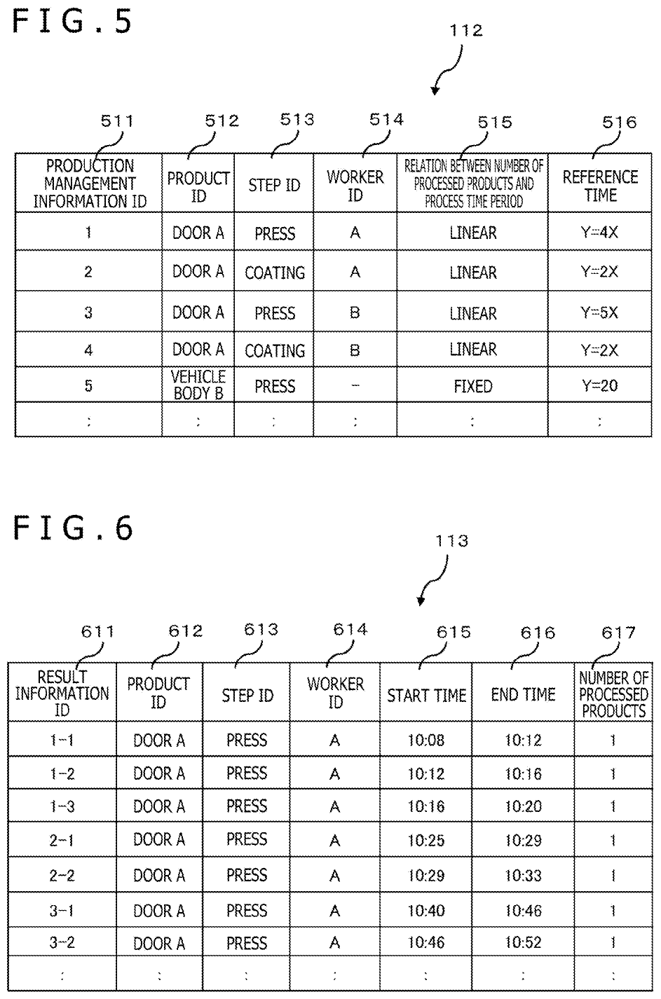

FIG. 5 shows one example of the production management information 112. As shown in FIG. 5, the production management information 112 is formed of one or more entries (records) each including a production management information ID 511, a production ID 512, a step ID 513, a worker ID 514, a relation 515 between the number of processed products and a processing time period, and a reference time 516. One entry in the production management information 112 corresponds to one production management information set.

An identifier of production management information (hereinafter, referred to as “production management information ID”) is set in the production management information ID 511. The aforementioned production ID is set in the production ID 512. The aforementioned step ID is set in the step ID 513. The aforementioned worker ID is set in the worker ID 514. Information (e.g., “linear,” “fixed”) indicating the relation between the number of processed products and the processing time period in this step, for the combination of this product, this step, and this worker, is set in the relation 515 between the number of processed products and the processing time period. A reference (standard) processing time period (hereinafter, referred to as “reference time”) that is taken to process one product in this step is set in the reference time 516. As shown in FIG. 5, the reference time Y is expressed by an expression (e.g., “Y=4X,” “Y=2X”) that represents the relation with a number X of the products, in the present example.

For example, in FIG. 5, an entry having “1” set as the production management information ID indicates that, in a case where a step the step ID of which is “press” for a product the production ID of which is “door A” is performed by a worker the worker ID of whom is “worker A,” the processing time period of this step is increased “linearly” in proportion to the number of processed products so that the reference time Y is “4X.”

It is to be noted that the production management information 112 may include information other than the shown information. For example, the production management information 112 may include information about equipment to be used in the step, information about a product producing option, and the like. In addition, the relation between the number of processed products and the processing time period is not limited to those shown in the drawing, and may be set in such a way that “the number of processed products increases stepwise by a prescribed number of processed products,” or “the processing time period increases exponentially with the number of processed products,” for example.

FIG. 6 shows one example of the result information (after conversion) 113. The result information (after conversion) 113 is obtained by converting the result information 111 (by performing time-division of entries), and includes information obtained by converting (time-dividing) the result information 111 into information that indicates the production efficiency (processing time period taken for a step) for a unit number (e.g., one) of products. As shown in FIG. 6, the result information (after conversion) 113 is formed of one or more entries (records) each including a result information ID 611, a production ID 612, a step

ID 613, a worker ID 614, a start time 615, an end time 616, and a number of processed products 617. One entry in the result information (after conversion) 113 corresponds to one of information sets (hereinafter, referred to as “result information (after conversion”) obtained by time-division of result information into information about a unit number (e.g., one).

An identifier of result information (hereinafter, referred to as “result information ID”) is set in the result information ID 611. In the present example, in the result information ID 611 of an entry obtained by conversion of the result information 111 (division of the result information 111 into entries), a result information ID obtained by adding a branch number (sub-number) to the original result information ID of the result information 111 is set. For example, three entries having “1-1,” “1-2,” and “1-3” set as the result information ID 611 of the result information (after conversion) 113 in FIG. 6, are obtained as a result of conversion (time-division into three parts) of the entry having “1” set as the result information ID 411 in FIG. 4. The aforementioned production ID is set in the production ID 612. The aforementioned step ID is set in the step ID 613. A clock time at which this step for the product is started is set in the start time 615. A clock time at which this step for the product is set in the end time 616. It is to be noted that the start time 615 and the end time 616 may include information about a date. Information that indicates the number of products processed in this step is set in the number of processed products 617.

Next, processes which are performed by the data analysis support apparatus 100 will be specifically explained.

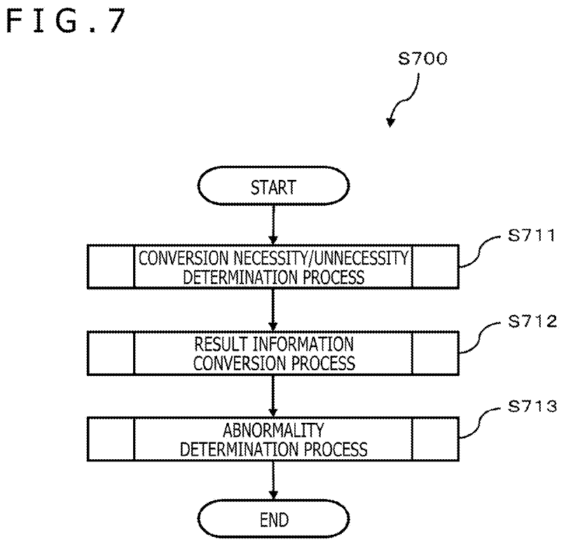

FIG. 7 is a flowchart for explaining a process (hereinafter, referred to as “data analysis process S700”) which is performed by the data analysis support apparatus 100. Upon receiving an instruction to execute this process from the user apparatus 300, or upon arrival of the start time (e.g., at regular intervals (every hour, a prescribed clock time of every day, or the like)), for example, the data analysis support apparatus 100 starts the data analysis process S700.

In the data analysis process S700, the data analysis support apparatus 100 first performs a process for determining whether conversion of the result information 111 is necessary or unnecessary (hereinafter, referred to as “conversion necessity/unnecessity determination process S711”). The details of the conversion necessity/unnecessity determination process S711 will be explained later.

Next, the data analysis support apparatus 100 creates the result information (after conversion) 113 by performing a process regarding conversion (time division) of the result information 111 (hereinafter, referred to as “result information conversion process S712”). The details of the result information conversion process S712 will be explained later.

Next, the data analysis support apparatus 100 determines whether an abnormality has occurred in the production state of the production site on the basis of the result information 111/the result information (after conversion) 113 and the production management information 112, and performs a process of presenting the details of the result information 111/the result information (after conversion) 113 and the result of the above determination to the user (hereinafter, referred to as “abnormality determination process S713”). The details of the abnormality determination process S713 will be explained later. Thereafter, the data analysis process S700 is ended.

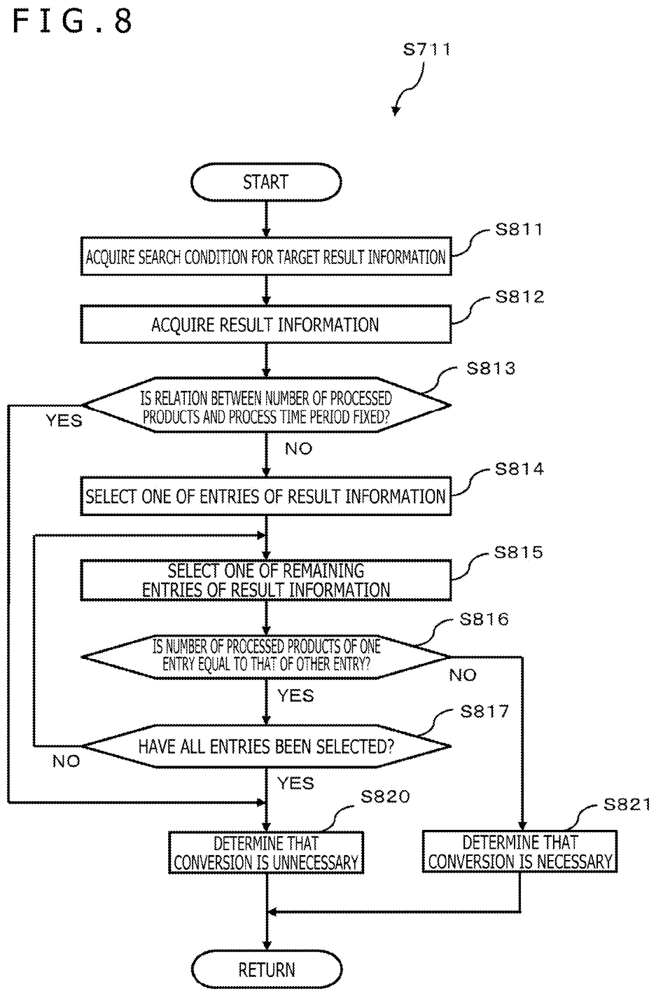

FIG. 8 is a flowchart for explaining the details of the conversion necessity/unnecessity determination process S711 in FIG.

7. Hereinafter, the conversion necessity/unnecessity determination process S711 will be explained with reference to FIG. 8.

First, the data analysis support apparatus 100 receives, from a user via the user apparatus 300, a search condition for the result information 111 to be analyzed (S811). Here, it is assumed that the data analysis support apparatus 100 receives a time section from “10:00” to “11:00” of the step “press” for the product “door A” performed by the worker “A,” as the search condition including a product, a step, a worker, and a time section. It is to be noted that, since the search condition is just one example, a material or the like to be processed in a step may be designated, for example.

Next, the data analysis support apparatus 100 acquires the result information 111 corresponding to the search condition, from the result information management apparatus 200 (S812).

Next, the data analysis support apparatus 100 determines whether or not the relation between the number of processed products and the processing time period is fixed in each entry of the acquired result information 111 (S813). Specifically, for each entry of the acquired result information 111, the data analysis support apparatus 100 determines whether or not the relation between the processed products and the processing time period is fixed by confirming the relation 515 between the number of processed products and the processing time period in the production management information 112 in FIG. 5. For example, regarding the entries having “1,” “2,” and “3” set as the result information ID 411 of the result information 111 in FIG. 4, the relation 515 between the number of processed products and the processing time period in an entry having “1” set as the production management information ID 511 of the production management information 112 is “linear.” Thus, the relation between the number of processed products and the processing time period is determined to be not “fixed.” When the relation between the number of processed products and the processing time period is determined to be fixed (S813: YES), the data analysis support apparatus 100 determines that conversion of the result information 111 is unnecessary, and stores this determination result (S820). Then, the conversion necessity/unnecessity determination process S711 is ended. When the relation between the number of processed products and the processing time period is determined to be not fixed (S813: NO), the data analysis support apparatus 100 executes the process from S814.

At S814, the data analysis support apparatus 100 selects one of the entries acquired at S812.

Next, the data analysis support apparatus 100 selects, from among the entries acquired at S812, another one different from the entry selected at S814 (S815).

Next, the data analysis support apparatus 100 determines whether the number of processed products 417 in the entry selected at S814 is equal to that in the entry selected at S815 (S816). For example, the data analysis support apparatus 100 selects an entry having “1” set as the result information ID 411, and an entry having “2” as the result information ID 411 from the result information 111 in FIG. 4. In the former entry, the number of processed products is “3.” In the latter entry, the number of processed products is “2.” Accordingly, the data analysis support apparatus 100 determines that these entries are different in the number of processed products. When these entries have the same number of processed products 417 (S816: YES), the data analysis support apparatus 100 executes S817. When these entries are different in the number of processed products 417 (S816: NO), the data analysis support apparatus 100 determines that conversion of the result information 111 is necessary, and stores this determination result (S821). Then, the conversion necessity/unnecessity determination process S711 is ended.

At S817, the data analysis support apparatus 100 determines whether or not all the entries selected at S812 (excluding the entry selected at S814) have been selected at S815. When not all the entries have been selected (S817: NO), the process returns to S815, and the process from S816 is executed for the unselected entries. When all the entries have been selected (S817: YES), the data analysis support apparatus 100 determines that conversion of the result information 111 is unnecessary, and stores the determination result (S820). Then, the conversion necessity/unnecessity determination process S711 is ended.

In the aforementioned manner, when there is a combination of entries different in the number of processed products 417 in each of the entries of the result information acquired at S812, the data analysis support apparatus 100 determines that “conversion of the result information is necessary.” When the entries of the result information acquired at S812 have the same values of the number of processed products 417, the data analysis support apparatus 100 determines that “conversion of the result information is unnecessary.”

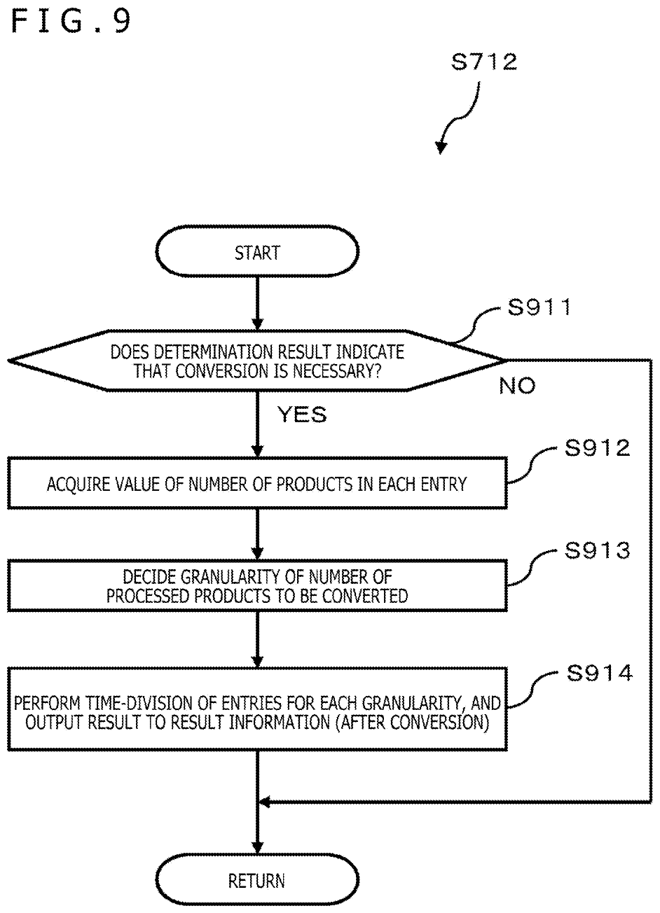

FIG. 9 is a flowchart for explaining the details of the result information conversion process S712 in FIG. 7. Hereinafter, the result information conversion process S712 will be explained with reference to FIG. 9.

As shown in FIG. 9, the data analysis support apparatus 100 first determines whether conversion of the result information 111 has been determined to be necessary as a result of the conversion necessity/unnecessity determination process S711 in FIG. 8 (S911). When conversion of the result information 111 has been determined to be necessary (S911: YES), the process proceeds to S912. When conversion of the result information 111 has been determined to be unnecessary (S911: NO), the data analysis support apparatus 100 ends the result information conversion process S712.

At S912, the data analysis support apparatus 100 acquires the values of the numbers of produced products 417 in the respective entries of the result information 111 acquired at S812 of the conversion necessity/unnecessity determination process S711 in FIG. 8. In the above example, from entries having “1,” “2,” and “3” as the result information ID 411 of the result information 111 in FIG. 4, “3,” “2,” and “2” are acquired as the number of processed products 417.

Next, the data analysis support apparatus 100 obtains the granularity (a unit number of products) of the number of processed products 417 in each entry for use in conversion of the result information 111 (S913). In the present example, the greatest common divisor of the numbers of processed products 417 in the respective result information sets acquired at S912 is defined as the granularity. In the above example, the data analysis support apparatus 100 obtains, as the granularity, “1” which is the greatest common divisor of “3,” “2,” and “2.” It is to be noted that a method for defining the granularity is not limited to a particular one. For example, the granularity may be a fixed value (e.g., “1”), or may be previously set by a user or the like.

Next, the data analysis support apparatus 100 performs conversion (time-division) of each of the entries in the result information 111 acquired at S812 of the conversion necessity/unnecessity determination process S711 in FIG. 8, by using the granularity decided at S913. Specifically, the data analysis support apparatus 100 performs time-division of each of the entries such that the entry is divided on the basis of each granularity, and reflects the result of the time-division in the result information (after conversion) 113 (S914). Thereafter, the data analysis support apparatus 100 ends the result information conversion process S712.

For example, regarding the entry having “1” set as the result information ID 411 of the result information 111 in FIG. 4, the number of processed products 417 is “3.” The data analysis support apparatus 100 performs time-division of this entry into three entries, which is obtained by dividing “3” by the granularity of “1.” The entries obtained by this time-division correspond to three entries having “1-1,” “1-2,” and “1-3” set as the result information ID 611 of the result information (after conversion) 113 in FIG. 6. It is to be noted that, in the present example, the data analysis support apparatus 100 sets the start time 615 and the end time 616 in each of the three entries such that the time period from the start time “10:08” to the end time “10:20” in the entry which has not been time-divided, is divided into three sections.

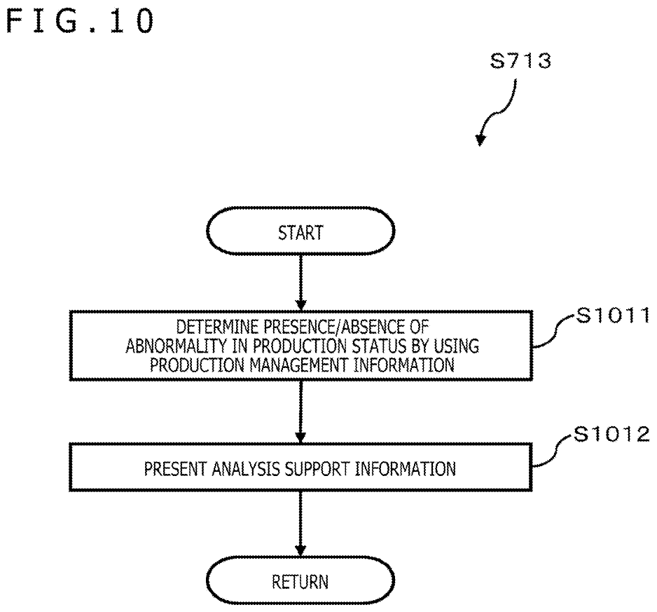

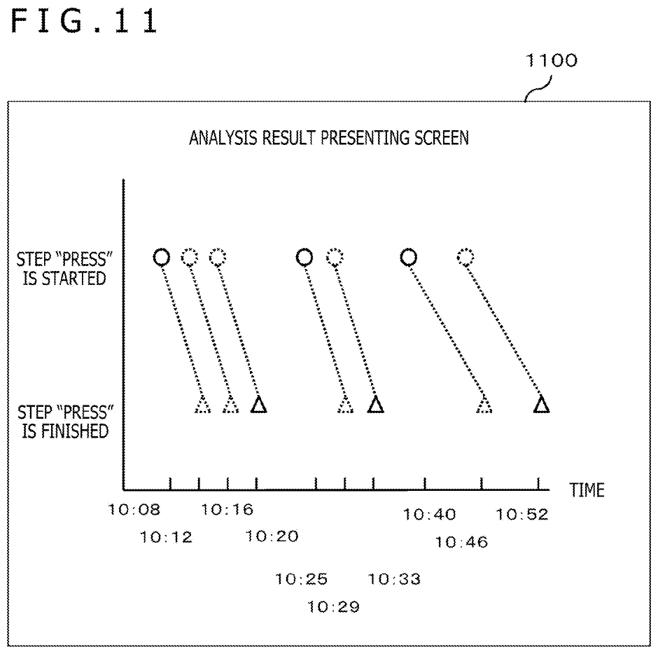

FIG. 10 is a flowchart for explaining the details of the abnormality determination process S713 in FIG. 7. Hereinafter, the abnormality determination process S713 will be explained with reference to FIG. 10.

First, the data analysis support apparatus 100 determines whether or not an abnormality has occurred in the production state of the production site by using the production management information 112 (S1011). Specifically, the data analysis support apparatus 100 determines whether or not the relation between the number of processed products and the processing time period (step progression degree per unit time) in the result information 111 or the result information (after conversion) 113 satisfies a relation set in the reference time 516 in the production management information 112. When satisfaction is determined, the data analysis support apparatus 100 determines that no abnormality has occurred in the production state of the production site. When satisfaction is not determined, the data analysis support apparatus 100 determines that an abnormality has occurred in the production state of the production site.

For example, regarding entries having “1-1,” “1-2,” “1-3,” “2-1,” and “2-2” set as the result information ID 611 of the result information (after conversion) 113 in FIG. 6, the number of processed products 617 is “1” and the difference (processing time period) between the start time 615 and the end time 616 is “4 minutes.” Thus, these entries satisfy “Y=4X” which is the reference time 516 in the production management information 112. Therefore, the data analysis support apparatus 100 determines that no abnormality has occurred in the production state of the production site.

For example, regarding entries having “3-1” and “3-2” set as the result information ID 611 of the result information (after conversion) 113 in FIG. 6, the number of processed products 617 is “1,” and the difference (processing time period) between the start time 615 and the end time 616 is “6 minutes” so that “Y=4X” which is the reference time 516 in the production management information 112 is not satisfied. Thus, the data analysis support apparatus 100 determines that a certain abnormality has occurred in the production state of the production site. It is to be noted that a calculation method for the abnormality determination is not limited to the aforementioned method. For example, a buffer time for allowing a certain degree of variation of a processing time may be provided for the reference time so that, in a case where the processing time period is deviated from the reference time even when the buffer time is taken into consideration, occurrence of an abnormality in the production state of the production site may be determined.

Next, the data analysis support apparatus 100 creates an analysis result presentation screen showing the determination result about the presence/absence of an abnormality, and the like, and presents the created analysis result presentation screen to the user via the user apparatus 300 (S1012).

For example, regarding the entries having “1” and “2” set as the result information ID 411 of the result information 111, the data analysis support apparatus 100 displays on the analysis result presentation screen to indicate that the entries having “1-1,” “1-2,” “1-3,” “2-1,” and “2-2” set as the result information ID 611 of the result information (after conversion) 113 are normal. In addition, regarding the entry having “3” set as the result information ID 611 of the result information 111, the data analysis support apparatus 100 displays the analysis result presentation screen indicating that both the entries having “3-1” and “3-2” set as the result information ID 611 of the result information (after conversion) 113 are abnormal.

FIG. 11 shows one example of the analysis result presentation screen. An analysis result presentation screen 1100 in FIG. 11 includes visualized information in graph form about seven entries having “1-1,” “1-2,” “1-3,” “2-1,” “2-2,” “3-1,” and “3-2” set as the result information ID 611 of the result information (after conversion) 113. In FIG. 11, each circular mark represents a point (position) corresponding to the start time of the step, and each triangular mark represents a point (position) corresponding to the end time of the step. Further, each line connects the start time to the end time for the same products or the same product group. These entries are obtained by dividing the entries “1,” “2,” and “3” set as the result information ID 411 of the result information 111, into three parts, two parts, and two parts, respectively. Each marks-line combination in this graph indicates result information for the same unit number (one).

Therefore, through comparison of the slopes (the step progression degree per unit time) of the respective combinations, the user can easily and properly determine the presence/absence of an abnormality in the production state of the production site. In the present example, the slope of the line of display information about the entry having “3” set as the result information ID 411 of the result information 111, that is, result information (after conversion) in which “3-1” and “3-2” are set as the result information ID 611 of the result information (after conversion) 113 is more moderate than those of the lines of the any other result information (after conversion). Therefore, the user can determine that an abnormality has occurred in the production state of the production site.

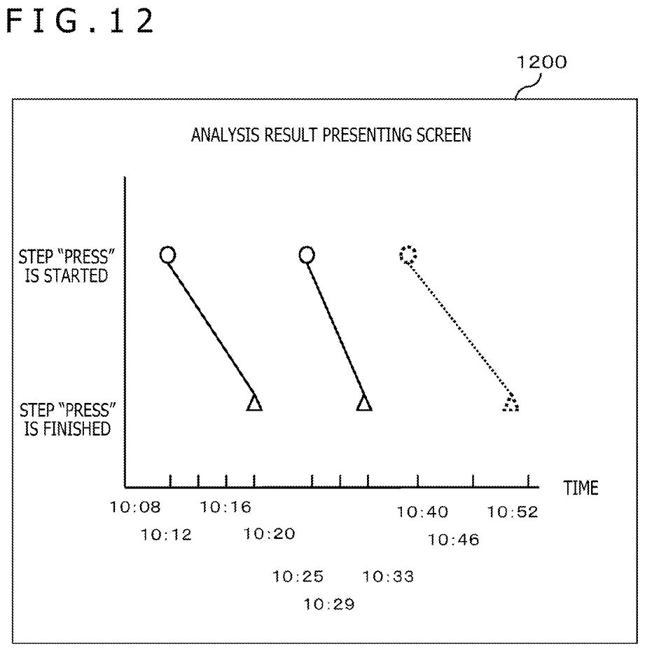

FIG. 12 shows another example of the analysis result presentation screen. An analysis result presentation screen 1200 shown in FIG. 12 is obtained by graphing the entries having “1,” “2,” and “3” set as the result information ID 411 of the result information 111, which is the original of the result information (after conversion) 113, in the same manner as that in FIG. 11. As shown in FIG. 12, in the present example, the marks-line combination of an entry including occurrence of an abnormality is highlighted (is displayed by a broken line in this example), and those of the remaining entries are displayed in a normal way (are displayed by solid lines in the present example). In this manner, the marks-line combination of an entry including the occurrence of an abnormality is highlighted so that a user can easily get to know that an abnormality in the production state of the production site has occurred for this entry. It is to be noted that a method for highlighting is not necessarily limited to a particular one. For example, highlighting may be achieved by using different colors, or different line weights. In addition, the graph in FIG. 11 and the graph in FIG. 12 may be combined (superimposed) and displayed in different forms (line types, colors, line weights, or the like).

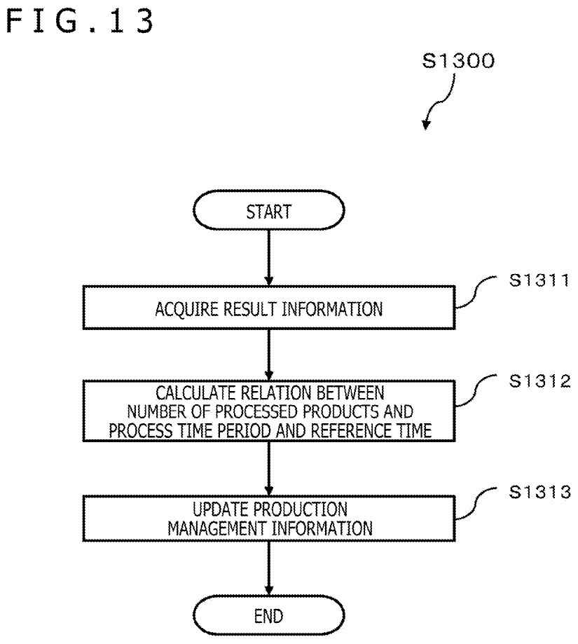

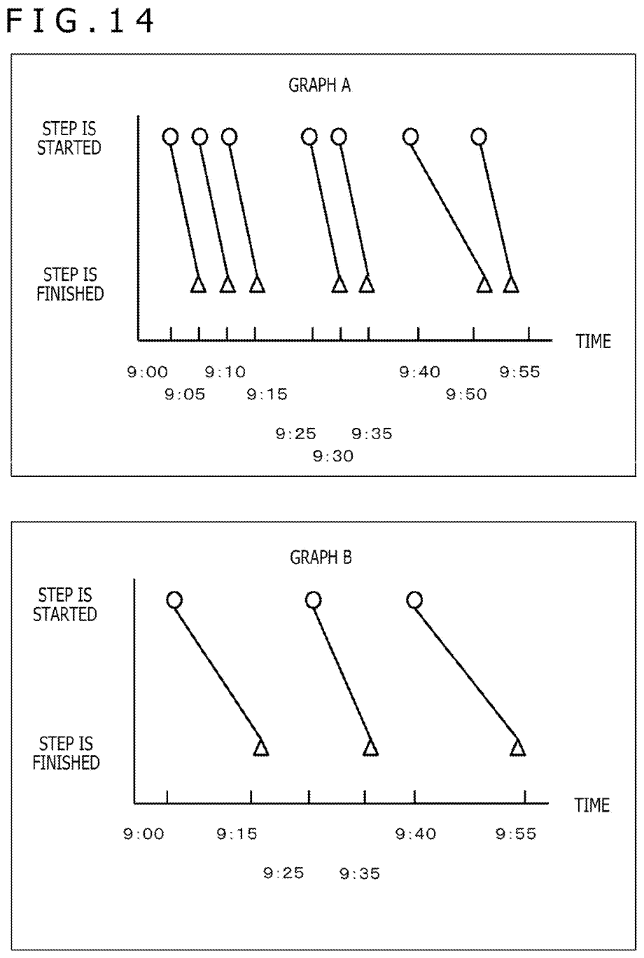

FIG. 13 is a flowchart for explaining a process (hereinafter, referred to as “production management information updating process S1300”) which the data analysis support apparatus 100 performs when updating the production management information 112. Upon acquiring the result information 111 from the result information management apparatus 200, or upon arrival of a prescribed timing (at regular intervals, (e.g., every hour or at a prescribed clock time of each day), for example), for example, the data analysis support apparatus 100 executes the production management information updating process S1300. Hereinafter, the production management information updating process S1300 will be explained with reference to FIG. 13.

First, the data analysis support apparatus 100 acquires, from the result information 111, entries having the same information stored in the step ID 413 and the worker ID 414 (S1311). For example, the data analysis support apparatus 100 acquires, as entries having “door A” set as the production ID 412, “press” set as the step ID 413, and “A” set as the worker ID 414 in the result information 111 in FIG. 4, the entries having “1” and “2” set as the result information ID 411. It is noted that a method for acquiring the result information 111 is not necessarily limited to a particular one. For example, the result information 111 sets having the same information stored in the production ID 412 and the step ID 413 in the result information 111 may be acquired, or entries of a previously designated arbitrary time section (e.g., each day, each month) may be acquired.

Next, the data analysis support apparatus 100 obtains the relation between the number of processed products and the processing time period, and a reference time on the basis of the acquired entries in the result information 111 (S1312). Specifically, by using the acquired result information 111 sets, the data analysis support apparatus 100 obtains an average processing time period of producing one product. For example, in the entries having “1” and “2” set as the result information ID 411 of the result information 111 in FIG. 4, “12 minutes” are taken to produce “three” products, and “8 minutes” are taken to produce “two” products. That is, in this case, “20 minutes” are taken to produce “five” products. Thus, the data analysis support apparatus 100 obtains the average processing time period by “4 minutes/one product =20 minutes/5 products.” Then, since “Y=4X” in which X represents the number of processed products and Y represents the reference time for the processing time period, the data analysis support apparatus 100 identifies that production is carried out while the relation between the number of processed products and the processing time period relation shows a “linear” proportion. It is to be noted that a calculation method for the relation between the number of processed products and the processing time period, and the reference time is not necessarily limited to a particular one. For example, the relation between the number of processed products and the processing time period and the reference time may be obtained after the result information 111 that seems to include an abnormality is previously excluded. In addition, through comparison with a prepared function (e.g., a quadratic function or a logarithmic function), the most approximate function may be defined as the relation between the number of processed products and the processing time period. A buffer time period may be taken into consideration for a certain level of variation of the reference time.

Next, the data analysis support apparatus 100 reflects, in the production management information 112, the obtained relation between the number of processed products and the processing time period and the obtained reference time (S1313). For example, regarding the step “press” for the product “door A” by the worker “A” obtained at S1312, “linear” is set for the relation 515 between the number of processed products and the processing time period, and “Y=4X” is set for the reference time 516. As explained so far, when acquiring a plurality sets of the result information 111 in different forms (the result information 111 including information that indicates step processing time periods for different unit numbers of products) from a production site, the data analysis support apparatus 100 according to the present embodiment performs time-division of at least any one of the result information 111 sets so that the result information set is divided into a plurality of result information sets each indicating a time period taken to perform the process for the same unit number of products. Accordingly, the presence/absence of an abnormality in the product producing state of the production site can be easily and properly determined.

Further, the data analysis support apparatus 100 creates a screen showing the plurality of result information sets in graph form with a time axis indicated by an abscissa and a progression status of the step indicated by an ordinate, and presents the screen to a user. Accordingly, the user can easily and properly determine the presence/absence of an abnormality in the production state of the production site by comparing the respective result information sets shown in the screen (the slopes of the lines (graph) of the respective result information sets).

In addition, the data analysis support apparatus 100 determines the presence/absence of an abnormality in each of result information sets (the production state of the production site) by comparing the progression degree of the result information set per unit time with a reference progression degree, and then, highlights a line (graph) of the result information set in which the presence of an abnormality has been determined. Accordingly, a user can easily get to know which result information set includes an abnormality, and can promptly take measures against the abnormality.

In the aforementioned mechanism, it is not necessary to separately provide a special mechanism such as a programmable logic controller (PLC). The aforementioned mechanism can be achieved at low cost with a light burden.

One embodiment of the present invention has been explained so far. However, the present invention is not limited to the above embodiment. It goes without saying that various modification can be made within the gist of the present invention. For example, the above embodiment exemplifies the present invention in detail in an easy-to-understand manner, and thus, the present invention is not necessarily limited to an apparatus including all the components explained above. In addition, any one of the components in the above embodiment may be deleted or replaced with any other component, or any other component may be added thereto.

Further, the aforementioned components, function units, processing units, processing means, and the like may be partially or entirely implemented by hardware that is, for example, designed on an integrated circuit. In addition, the aforementioned components, functions, and the like, may be implemented by software by a processor interpreting and executing a program for implementing these functions. Information about the program for executing the functions, a table, a file, and the like can be put in a recording device such as a memory, a hard disk, or an SSD, or in a recording device such as an IC card, an SD card, or a DVD.

Further, the aforementioned arrangement of the function units, the processing units, and the databases in each of the information processing apparatuses is just one example. The aforementioned arrangement of the function units, the processing units, and the databases may be changed to an optimum arrangement form from the viewpoint of the performance of the hardware/software of the apparatuses, the processing efficiency, the communication efficiency, and the like.

Moreover, the configuration (e.g., schema) of each database for storing the aforementioned various data can be flexibly changed from the view point of the efficient use of resources, improvement of the processing efficiency, improvement of the access efficiency, improvement of the search efficiency, and the like.

What is claimed is:

1. A data analysis support apparatus that is formed of an information processing apparatus, comprising:
a result information acquisition unit configured to acquire
first result information which is result information acquired for a product produced through a prescribed step, the first result information including information that indicates a first processing time period which is a processing time period of the step for a first number of the products, and
second result information which is result information including information that indicates a second processing time period which is a processing time of the step for a second number of the products produced through the step, the second number being different from the first number; and
a result information conversion unit configured to convert the first result information and the second result information into a plurality of result information sets by performing time-division of the first result information and/or the second result information such that the result information sets each indicate a time period taken to perform the step for a same unit number of the products.

2. The data analysis support apparatus according to claim 1, further comprising:
an information presentation unit configured to create a screen showing, in graph form, the plurality of result information sets obtained by the time-division, with a time axis indicated by an abscissa and a progression status of the step indicated by an ordinate.

3. The data analysis support apparatus according to claim 2, wherein
the processing time period is defined by a start time at which the step is started and an end time at which the step is ended, and
the information presentation unit indicates a line connecting a point corresponding to the start time with a point corresponding to the end time in the graph form.

4. The data analysis support apparatus according to claim 1, wherein
the result information conversion unit sets, as the unit number, a greatest common divisor of the first number and the second number.

5. The data analysis support apparatus according to claim 1, wherein
a step progression degree per unit time is obtained for each of the plurality of result information sets obtained by the time-division, and presence/absence of an abnormality in each of the result information sets is determined by comparison of the obtained progression degree with a reference progression degree.

6. The data analysis support apparatus according to claim 5, further comprising:
an information presentation unit configured to create a screen showing the plurality of result information sets obtained by the time-division, wherein
the information presentation unit highlights, among the plurality of result information sets obtained by the time-division, a result information set in which the presence of an abnormality has been determined.

7. A data analysis support method executed by an information processing apparatus, comprising:
acquiring
first result information which is result information acquired for a product produced through a prescribed step, the first result information including information that indicates a first processing time period which is a processing time period of the step for a first number of the products, and
second result information which is result information including information that indicates a second processing time period which is a processing time of the step for a second number of the products produced through the step, the second number being different from the first number; and
converting the first result information and the second result information into a plurality of result information sets by performing time-division of the first result information and/or the second result information such that the result information sets each indicate a time period taken to perform the step for the same unit number of the products.

8. The data analysis support method according to claim 7, further comprising:
creating a screen showing, in graph form, the plurality of result information sets obtained by the time-division, with a time axis indicated by an abscissa and a progression status of the step indicated by an ordinate.

9. The data analysis support method according to claim 8, wherein
the processing time period is defined by a start time at which a process of the step is started and an end time at which the process is ended, and
the information processing apparatus further indicates a line connecting a point corresponding to the start time with a point corresponding to the end time in the graph form.

10. The data analysis support method according to claim 7, further comprising:
setting, as the unit number, a greatest common divisor of the first number and the second number.

11. The data analysis support method according to claim 7, further comprising:
obtaining a step progression degree per unit time for each of the plurality of result information sets obtained by the time-division, and determining presence/absence of an abnormality in each of the result information sets by comparison of the obtained progression degree with a reference progression degree.

12. The data analysis support method according to claim 11, further comprising:
creating a screen showing the plurality of result information sets obtained by the time-division; and
highlighting, among the plurality of result information sets obtained by the time-division, the result information set in which the presence of an abnormality has been determined.
